(19) United States
(12) Patent Application Publication
(10) Pub. No.: US 2005/0044523 A1
(43) Pub. Date: Feb. 24, 2005

(54) Method and system for compiling Java code with referenced classes in a workspace environment

(75) Inventor: David Wendt, Apex, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/644,357

(22) Filed: Aug. 20, 2003

(51) Int. Cl. G06F 7/00

(52) U.S. Cl. 717/100

(57) ABSTRACT

The present invention is a method, system, and computer program product for compiling Java code. In accordance with the present invention, Java code that references classes residing in a workspace can be complied. In accordance with the present invention, a workspace identifier is placed within the classpath to indicate the location of the referenced classes that may reside within a workspace. The present invention provides a compiler having a classpath wherein the compiler operates by performing the following steps: 1) determining if a referenced class file is located in a workspace; 2) locating the class file; 3) accessing the class file; and 4) returning the class file data to the compiler.

### FIELD OF THE INVENTION

The present invention relates to computer resource sharing. More particularly, it deals with accessing class files by a Java compiler operating in conjunction with an environment that includes workspaces.

### BACKGROUND OF THE INVENTION

Web sites have become increasingly more complex as the use of the Internet has increased. Web sites today consist of many files of many types which together form the complete web site. Often, these sites are not maintained by a single webmaster. Instead, an entire team of individuals may all be updating portions of the web site simultaneously. With many programmers working on a web site simultaneously, resource sharing is an issue. One programmer might be working on a particular file for a web site, and a different programmer might need to use this same file in conjunction with a file or page he or she is editing. In addition, the complexity of the editing process might mean that a programmer could be working on a particular file for an extended length of time, rendering the file inaccessible for the entire time the file was being edited or updated.

Web content management systems such as WebSphere Portal by IBM Corporation (Armonk, N.Y.) have been developed to provide workspace isolation of web content during web site editing. A workspace is a virtual area assigned to a particular developer or set of developers. A workspace can exist on the local computer from which the developer is accessing the site, or alternatively, it can be a designated area within the server itself. A developer can place a copy of a file in the workspace in order to update or edit it, while the original file remains available to users of the site, or to other developers. In other words, the programmer creates a “working copy” that is used for editing. The file that is being edited or updated remains in the programmer's workspace until the work being performed on it is complete, at which time the programmer replaces the existing file on the web site with the new file. Systems such as WebSpere Portal allow for only users in a particular workspace to see changes to the web site content, while other users of the web site continue to view the unedited or base version of the content.

A method for sharing dynamic content files during web site editing is the subject of copending application Ser. No. 10/163,470, filed Jun. 6, 2002, which is hereby incorporated by reference. The method taught in the referenced co-pending application allows for workspace isolation of dynamic content. A dynamic content file, such as JSP file, can be executed within a workspace, while the original dynamic content file remains available to users outside of the workspace.

The systems currently used to provide workspace isolation use a Java compiler, such as the javac compiler that is supplied as part of JDK (Sun Microsystems, Santa Clara, Calif.). The Java compiler converts Java source code (having a .java extension) into complied class files (having a .class extension). Class files consist of platform independent byte code instructions capable of execution. Once the java source file has been compiled in to a class file, the class file can be executed repeatedly without the need for re-accessing the source file.

The compilers in accordance with the prior art are file system based, which means the information used by the compiler is located using directories of file names in file folders. The class file is stored on the file system after it is compiled. Additionally, during the compile process, a source file may reference a previously compiled class file. For example, a .JAVA file that is used to welcome a user to a web page (e.g., WELCOME.JAVA) may also be programmed to display the current date. The date display could be accomplished using a previously compiled class file for displaying the date by referencing the required class file during the compile of the WELCOME.JAVA file.

In the prior art, a referenced class is located by a specifying file path (file name and directory) of the referenced class in the classpath command within the compiler. While this allows access to files found on the file system, a problem occurs if the class file desired is located within a workspace. When a referenced class is located in a workspace, it cannot be resolved as there is no file system directory that can be inserted in the classpath to direct the compiler to the referenced class.

Accordingly, it is desired to be able to access referenced classes that reside within a workspace instead of on the file system.

### SUMMARY OF THE INVENTION

The present invention is a method, system, and computer program product for compiling Java code. In accordance with the present invention, Java code that references classes residing in a workspace can be complied. In accordance with the present invention, a workspace identifier is placed within the classpath to indicate the location of the referenced classes that may reside within a workspace.

The present invention provides a compiler having a classpath wherein the compiler operates by performing the following steps: 1) determining if a referenced class file is located in a workspace; 2) locating the class file; 3) accessing the class file; and 4) returning the class file data to the compiler.

In accordance with a preferred embodiment, the files on a web site are serviced using a file database, and a class file is allocated to a workspace by creating an additional entry in the file database. The class file is invoked by the compiler through the database.

### BRIEF DESCRIPTION OF THE DRAWINGS

FIG. 1 is a block diagram of the elements of a computer environment in accordance with the present invention.

FIG. 2 is a flow chart illustrating the steps executed by a Java compiler in accordance with the present invention.

### DETAILED DESCRIPTION OF THE INVENTION

The present invention described herein is a compiler that allows for class files residing in a workspace that are referenced during the compile process of a source file to be resolved.

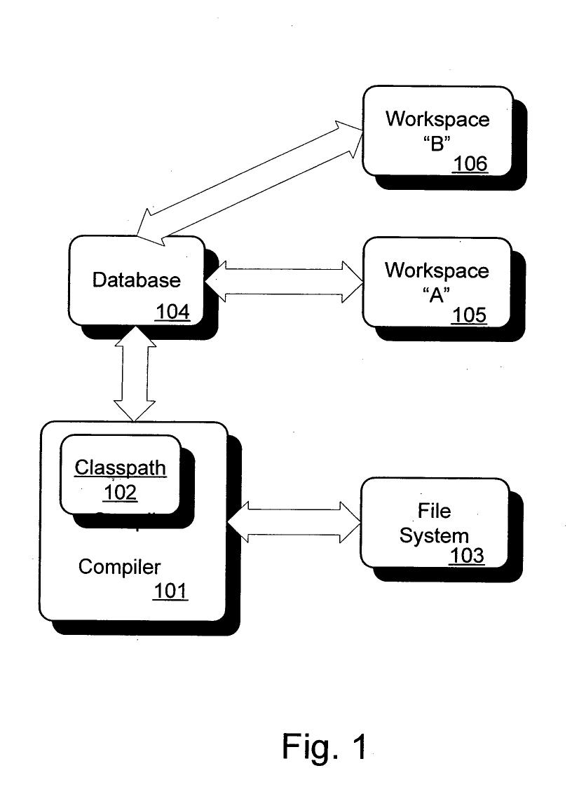

FIG. 1 illustrates an exemplary environment in which a compiler in accordance with the present invention can operate. The various components can be located on a single computer, or alternatively one or more components can reside on one or more remote computers. A compiler 101 is used to compile a source file. The source file resides on the file system 103, and is read by the compiler 101 upon execution. Contained within the compiler 101 is a classpath 102 that identifies the location of any referenced classes (i.e., classes that are called within the source file being compiled).

The system also contains one or more workspaces 105, 106. In the exemplary embodiment, a file database 104 is used to service the files on the web site. A file is allocated to a workspace by creating an additional entry in the file database 104. The database structure 104 is used to store file data content. This type of file architecture allows for efficient implementation of workspaces. It should be understood, however, that the present invention can operate in alternative system architectures, such as complex file directory structures that also allow for partitioning into workspaces. The system can contain numerous workspaces, with each workspace identified by a unique name. For simplicity, the illustrated environment shows two workspaces that have been identified as “workspace A” 105 and “workspace B” 106.

Previously compiled class files can reside on the file system or alternatively within any workspace in the system. In the prior art, when a source file is compiled within compiler 101, referenced classes are called by specifying within the classpath 102 the location of files on the file system in which the classes are contained. Compiled classes can be found as a single .CLASS file, or alternatively can be grouped with several class files in a .ZIP or .JAR file. For example, a prior art classpath might contain the following information:
CLASSPATH=d:\directory1\subdirectory1\depclass1.zip;d:\directory2\subdirectory2\depclass2.jar

In this instance, a compiler searching for a particular dependent class first searches the .zip file located in directory1, subdirectory1 on drive d. If it does not locate the desired file in this location, the .jar file located indirectory 2, subdirectory2 is searched. All locations specified in the classpath are searched in order until the desired class file is located. If the file is not located, the class content cannot be returned.

Prior art file system based compilers are unable to return information from class files that do not reside in the file system 103, but rather are contained in a workspace (e.g., workspace 105). The present invention overcomes this problem by creating a workspace indicator to redirect the compiler from the file system to a workspace. For example, a classpath containing a workspace indicator might read as follows:
CLASSPATH=d:\directory1\subdirectory1\depclass1.zip;wsident@userID@pID@ws1

In this example, the compiler looks initially to the specified location on the file system (d:\directory1\subdirectory1\depclass1.zip) in the same manner as was done in the prior art. If the class is not found in this location, the compiler looks to the next item in the classpath, which in this example is a workspace indicator, wsident@userID@pID@ws1. The workspace indicator instructs the compiler to attempt to access the desired class file from a workspace location instead of from a location on the file system.

The workspace indicator comprises several parts, with the various parts separated by a separator character. A string of characters (i.e., signature string) is used to distinguish the workspace identifier from file system directory paths. The indicator also contains identification characters to identify the user and project that created the referenced class to be accessed. This provides security by limiting database access to those users authorized to access the workspace containing the referenced class. Finally, the workspace identifier contains the workspace name to direct the compiler to the correct workspace (via the database). In this example, the initial characters “wsident” indicates that this indicator identifies a workspace location, the “userID” characters identify a user, the “pID” characters identify a project, and the “ws1” characters identify a particular workspace (e.g., workspace 1). In this example, the “@” character is used as the separator, although other separator characters could be chosen.

In the example above, the workspace identifier is located in the classpath following a file system path designation. It should, however, be understood that the workspace identifier could be at any position in the classpath, and a classpath can comprise any combination of file system path designations and workspace identifiers.

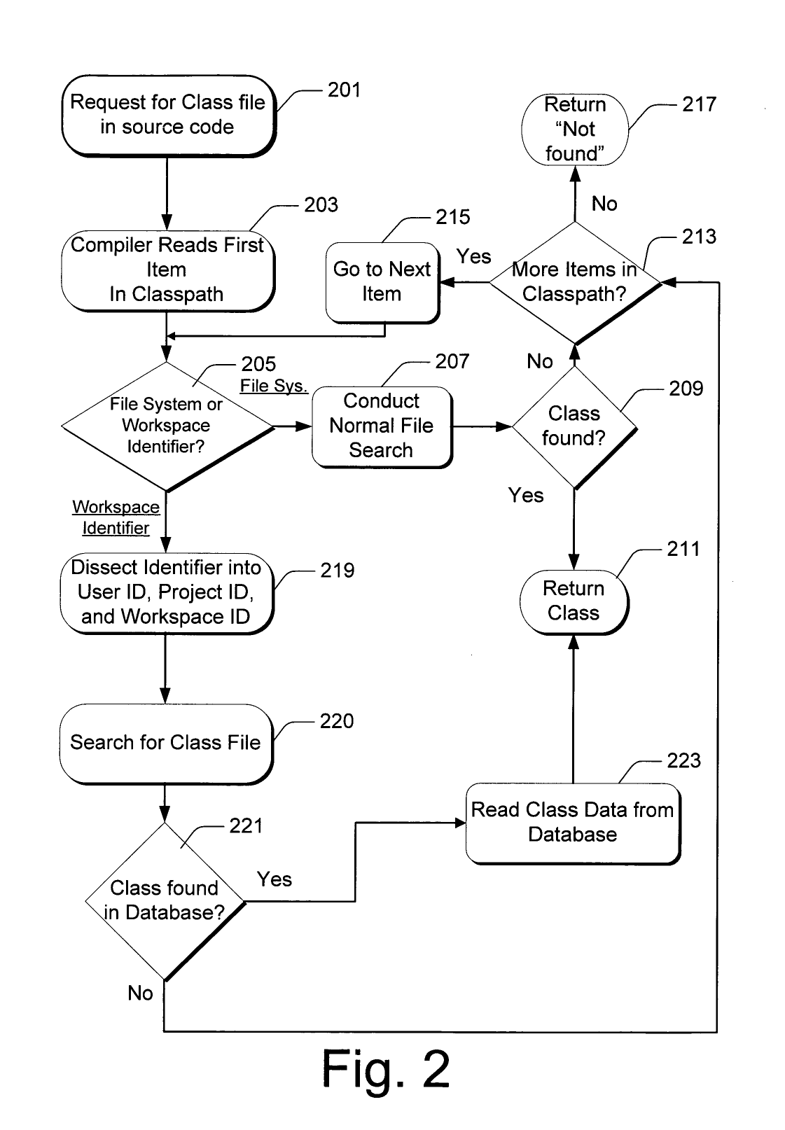

FIG. 2 is a flow chart illustrating the steps executed by the compiler to locate a referenced class file. Initially, the source code being compiled will contain a request for a class file, which causes the compiler to reference the classpath to search for the referenced class (step 201). The first item in the classpath is read (step 203). The compiler checks to see if the item is a file system path or workspace indicator (step 205). If the item in the class path is a file system path, the compiler processes the file system path in the normal manner as known in the prior art by searching the specified location on the file system for the desired class (step 207). The compiler checks to see if the desired class is present at the specified location (step 209) and, if so, returns the class (step 211). If not, the compiler checks to see if there are additional items in the classpath (step 213). If so, the compiler advances to the next item (step 215) and repeats the process. If the end of the classpath has been reached and the referenced class has not been located, the message “not found” is returned (step 217).

If an item is reached in the classpath that is a workspace identifier, the complier dissects the item into its various components, e.g., user ID, project ID, and workspace ID (step 219). Using the information in the workspace identifier, the compiler checks the designated database for the desired class (step 220). In addition to checking the database for .CLASS files that correspond to the desired class, .JAR files are also checked to determine if the class has been combined with other classes into a .JAR file. If the class is found (step 221), it is read from the database (step 223) and returned (step 211). If the class is not found, the compiler checks to see if there are additional items in the classpath (step 213). If so, the compiler advances to the next item (step 215) and repeats the process. If the end of the classpath has been reached and the referenced class has not been located, the message “not found” is returned (step 217).

The present invention has been described with reference to a Java compiler compiling Java source code. It should, however, be understood that the present invention can be used in conjunction with any compilable language (e.g., C, C++).

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage on a user workstation. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Addressing referenced classes during the compiling of source code in accordance with the present invention provides a means to access class files contained in the workspace without the need to create copies of the class files in the file system. This allows for workspace isolation desired by web designers without the need for excess file duplication or added resource management. It enables class editing to be completed using the workspace concept, while still permitting source files that reference these classes to be executed while the class file resides in a workspace.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

1. A method for compiling source code using a compiler having a classpath, comprising the steps of:
1) determining if a referenced class file is located in a workspace;
2) locating said class file in said workspace;
3) accessing said class file; and
4) returning said class file data to said compiler.

2. The method as set forth in claim 1, wherein the step of locating said class file further comprises the steps of:
identifying a location of a class using a workspace indicator in said classpath; and
reading said class from said location.

3. The method as set forth in claim 2, wherein said indicator comprises a signature string, a user ID, a project ID, and a workspace name.

4. The method as set forth in claim 2, wherein the step of determining if a referenced class file is located in a workspace further comprises the steps of:
reading an item from said classpath;
determining if said item references said file system or said workspace;
searching a file system directory specified by said item if said item references said file system; and
searching said workspace if said item references said workspace.

5. The method as set forth in claim 2, wherein said class file data is contained in a database.

6. The method as set forth in claim 1, wherein said class file is contained within a .JAR file in said workspace.

7. The method as set forth in claim 1, wherein said source code is Java.

8. A computer program product for compiling source code, comprising computer executable instructions for:
1) determining if a referenced class file is located in a workspace;
2) locating said class file;
3) accessing said class file; and
4) returning said class file data to said compiler.

9. The computer program product as set forth in claim 8, wherein the computer executable instructions for locating said class file further comprises computer executable instructions for:
identifying a location of a class using a workspace indicator in said classpath; and
reading said class from said location.

10. The computer program product as set forth in claim 9, wherein said indicator comprises a signature string, a user ID, a project ID, and a workspace name.

11. The computer program product as set forth in claim 8, wherein the step of determining if a referenced class file is located in a workspace further computer executable instructions for:
reading an item from said classpath;
determining if said item references said file system or said workspace;
searching a file system directory specified by said item if said item references said file system;
searching said workspace if said item references said workspace.

12. The computer program product as set forth in claim 8, wherein said class file is contained in a database.

13. The computer program product as set forth in claim 8, wherein said class file is contained in a .JAR file.

14. The computer program product as set forth in claim 8, wherein said source code is Java.

15. A system for compiling source code using a compiler having a classpath, comprising:
at least one workspace;
at least one referenced class file;
wherein said compiler determines if a said referenced class file is located in a workspace, accesses said referenced class file, and returns class data from said referenced class file.

16. The system as set forth in claim 15, wherein said compiler identifies a location of said class file using a workspace indicator in said classpath.

17. The system as set forth in claim 16, wherein said indicator comprises a signature string, a user ID, a project ID, and a workspace name.

18. The system as set forth in claim 15, wherein said class file is contained in a database.

19. The system as set forth in claim 15, wherein said class file is contained in a .JAR file.

20. The system as set forth in claim 15, wherein said source code is Java.
